(19) United States
(12) Patent Application Publication
(10) Pub. No.: US 2020/0164579 A1
(43) Pub. Date: May 28, 2020

(54) THREE-DIMENSIONAL PRINTING APPARATUS

(71) Applicant: Roland DG Corporation, Hamamatsu-shi (JP)

(72) Inventor: Fumiyoshi IWASE, Hamamatsu-shi (JP)

(21) Appl. No.: 16/684,776

(22) Filed: Nov. 15, 2019

(30) Foreign Application Priority Data
Nov. 22, 2018 (JP) 2018-219399

(51) Int. Cl. B29C 64/245; B29C 64/255; B29C 64/232; B29C 64/209; B29C 64/357

(52) U.S. Cl. CPC B29C 64/245; B29C 64/255; B29K 2105/251; B29C 64/209; B29C 64/357; B29C 64/232

(57) ABSTRACT

A three-dimensional printing apparatus includes a body, a printing tank, a first table, a feeding tank, a second table, a collecting tank, a third table, a spreader, a support, and a controller. The first table is disposed in the printing tank. The second table is disposed in the feeding tank. The third table is disposed in the collecting tank. The support supports the spreader. After the three-dimensional printing apparatus has finished printing a three-dimensional object, the controller raises the third table and the first table, lowers the second table, and moves the support relative to the body from the downstream side to the upstream side in a scanning direction such that a powder material placed on the third table and the first table is returned to a storage space of the feeding tank by the spreader.

### CROSS REFERENCE TO RELATED APPLICATIONS

This application claims the benefit of priority to Japanese Patent Application No. 2018-219399 filed on Nov. 22, 2018. The entire contents of this application are hereby incorporated herein by reference.

### BACKGROUND OF THE INVENTION

### 1. Field of the Invention

The present invention relates to three-dimensional printing apparatuses.

### 2. Description of the Related Art

A three-dimensional printing method known in the related art involves discharging a curing liquid onto a powder material so as to define a thin cured layer having a desired cross-sectional shape, and sequentially stacking such cured layers so as to print a three-dimensional object. Printing a three-dimensional object by such a method requires feeding a powder material onto a powder material layer including a cured layer defined, such that a new powder material layer is defined thereon. In many cases, an excess portion of the powder material that has not been used to define the new powder material layer is collected.

JP 2018-47570 A, for example, discloses a three-dimensional printing apparatus including a printing tank, a spreader (which is referred to as a “flattening roller”), and a collecting tank. A three-dimensional object is printed in the printing tank. The spreader feeds a powder material to the printing tank. An excess portion of the powder material is collected into the collecting tank. The collecting tank disclosed in JP 2018-47570 A is disposed side by side with the printing tank. The collecting tank includes an internal space into which an excess portion of the powder material falls. The internal space is open upward. The spreader conveys an excess portion of the powder material such that the excess portion of the powder material falls into the internal space of the collecting tank.

The three-dimensional printing apparatus disclosed in JP 2018-47570 A unfortunately has a large amount of powder material remaining in the printing tank and the collecting tank after having finished printing a three-dimensional object. One conventional solution to this problem is to manually return the powder material, remaining in the printing tank and the collecting tank, to a feeding tank by an operator using, for example, a scoop or a shovel. Another conventional solution is to return the remaining powder material to the feeding tank by sucking the remaining powder material using a sucking device.

Manually returning the remaining powder material to the feeding tank by the operator, however, requires time and effort and increases the burden on the operator. Manually returning the powder material to the feeding tank also involves digging up the powder material, so that the powder material may swirl in the air. This may adversely affect the health of the operator and the performance of components of the three-dimensional printing apparatus. Returning the powder material to the feeding tank using the sucking device reduces the burden on the operator. For example, when the powder material is mixed powder, however, sucking the powder material using the sucking device promotes separation of the powder material. Printing a three-dimensional object using the separated powder material may partially reduce the strength of the resulting three-dimensional object.

### SUMMARY OF THE INVENTION

Accordingly, preferred embodiments of the present invention provide three-dimensional printing apparatuses each being capable of easily returning a powder material remaining in a printing tank and a collecting tank to a feeding tank.

A preferred embodiment of the present invention provides a three-dimensional printing apparatus to print a three-dimensional object by sequentially stacking cured layers each defined by a curing a powder material. The three-dimensional printing apparatus includes a body, a printing tank, a first table, a first elevator, a feeding tank, a second table, a second elevator, a spreader, a support, a collecting tank, a third table, a third elevator, a discharge head, a conveyor, and a controller. The body holds the three-dimensional object being printed. The printing tank is disposed in the body. The printing tank includes a printing space in which the powder material is to be stored and the three-dimensional object is to be printed. The powder material is to be placed on the first table. The first table is disposed in the printing tank. The first elevator is disposed in body. The first elevator raises and lowers the first table. The feeding tank is disposed in the body such that the feeding tank is located on a first side in a first direction relative to the printing tank. The feeding tank includes a storage space to store the powder material to be fed to the printing tank. The powder material is to be placed on the second table. The second table is disposed in the feeding tank. The second elevator is disposed in the body. The second elevator raises and lowers the second table. The spreader conveys the powder material placed on the second table to the printing tank so as to spread the powder material through the printing space. The support supports the spreader. The collecting tank is disposed in the body such that the collecting tank is located on a second side in the first direction relative to the printing tank. The collecting tank includes a collecting space to collect an excess portion of the powder material that has not been stored in the printing space. The powder material is to be placed on the third table. The third table is disposed in the collecting tank. The third elevator is disposed in the body. The third elevator raises and lowers the third table. The discharge head discharges a curing liquid onto the powder material stored in the printing space. The conveyor moves one of the body and the support relative to the other one of the body and the support in the first direction. The controller controls the first elevator, the second elevator, the third elevator, the discharge head, and the conveyor. After the three-dimensional printing apparatus has finished printing the three-dimensional object, the controller raises the third table and the first table, lowers the second table, and moves the support relative to the body from the second side to the first side in the first direction such that the powder material placed on the third table and the first table is returned to the storage space of the feeding tank by the spreader.

After the three-dimensional printing apparatus according to the present preferred embodiment has finished printing the three-dimensional object, the controller controls the third elevator so as to raise the third table, and controls the first elevator so as to raise the first table. Thus, a portion of the powder material placed on the third table is raised above the collecting space, and a portion of the powder material placed on the first table is raised above the printing space. The controller controls the second elevator so as to lower the second table. This increases the capacity of the storage space of the feeding tank. The controller controls the conveyor so as to move the support relative to the body from the second side to the first side in the first direction. During this movement, the spreader supported by the support conveys the portions of the powder material, placed on the third table and the first table, from the second side to the first side in the first direction so as to return the portions of the powder material to the storage space of the feeding tank. Accordingly, controlling the first table, the second table, the third table, and the conveyor in this manner easily returns the powder material (which remains in the printing tank and the collecting tank after the three-dimensional printing apparatus has finished printing the three-dimensional object) to the feeding tank.

Various preferred embodiments of the present invention provide three-dimensional printing apparatuses each being capable of easily returning a powder material remaining in a printing tank and a collecting tank to a feeding tank.

The above and other elements, features, steps, characteristics and advantages of the present invention will become more apparent from the following detailed description of the preferred embodiments with reference to the attached drawings.

### BRIEF DESCRIPTION OF THE DRAWINGS

FIG. 1 is a cross-sectional view of a three-dimensional printing apparatus according to a preferred embodiment of the present invention.

FIG. 2 is a plan view of the three-dimensional printing apparatus according to the present preferred embodiment of the present invention.

FIG. 3 is a block diagram of a control system of the three-dimensional printing apparatus according to the present preferred embodiment of the present invention.

FIG. 4 is a cross-sectional view of the three-dimensional printing apparatus that has finished printing a three-dimensional object.

FIG. 5 is a cross-sectional view of the three-dimensional printing apparatus after the three-dimensional object printed has been removed from a printing tank.

FIG. 6 is a cross-sectional view of the three-dimensional printing apparatus according to the present preferred embodiment after a first table and a third table have been raised and a second table has been lowered.

FIG. 7 is a cross-sectional view of the three-dimensional printing apparatus according to the present preferred embodiment of the present invention after a support has been moved in a backward direction.

FIG. 8 is a cross-sectional view of the three-dimensional printing apparatus according to the present preferred embodiment of the present invention after the first table and the third table have been further raised and the second table has been further lowered.

FIG. 9 is a cross-sectional view of the three-dimensional printing apparatus according to the present preferred embodiment of the present invention after the support has been moved in the backward direction.

FIG. 10 is a plan view of a plate according to another preferred embodiment of the present invention.

FIG. 11 is a plan view of a plate according to still another preferred embodiment of the present invention.

FIG. 12 is a cross-sectional view of a plate according to yet another preferred embodiment of the present invention.

### DETAILED DESCRIPTION OF THE PREFERRED EMBODIMENTS

Three-dimensional printing apparatuses according to preferred embodiments of the present invention will be described below with reference to the drawings. The preferred embodiments described below are naturally not intended to limit the present invention in any way. Components or elements having the same functions are identified by the same reference signs, and description thereof will be simplified or omitted when deemed redundant.

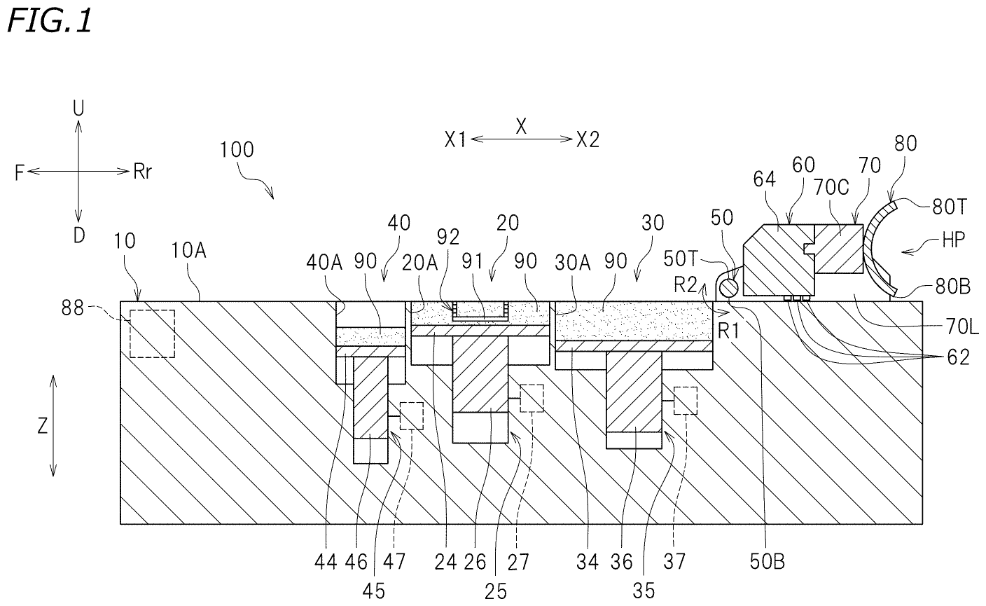

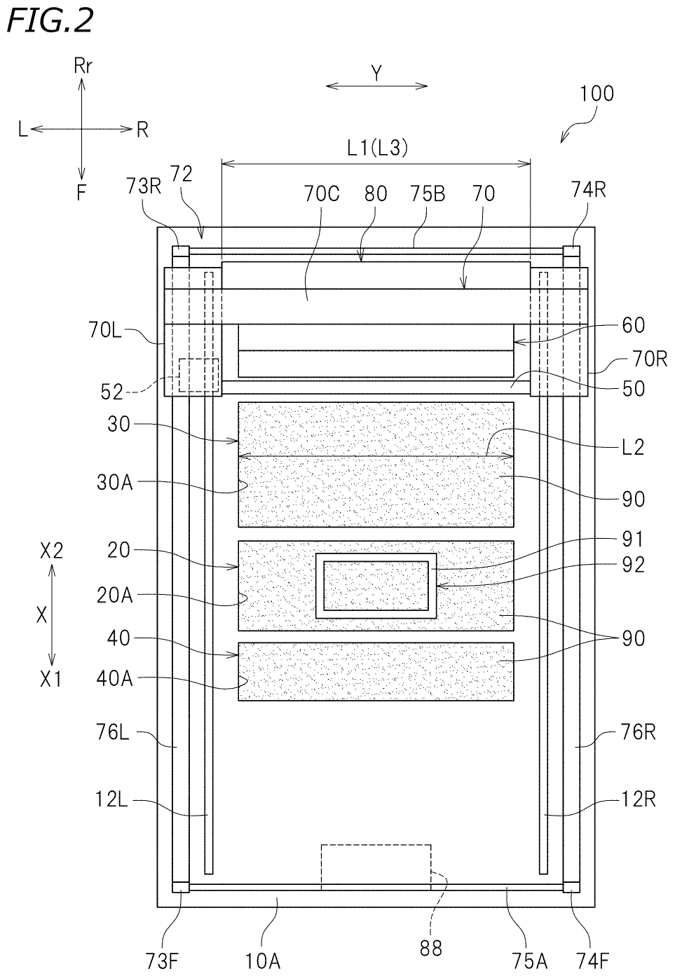

FIG. 1 is a cross-sectional view of a three-dimensional printing apparatus 100 according to a preferred embodiment of the present invention. FIG. 2 is a plan view of the three-dimensional printing apparatus 100 according to the present preferred embodiment. The reference sign F in the drawings represents front. The reference sign Rr in the drawings represents rear. As used herein, the terms “right”, “left”, “up”, and “down” respectively refer to right, left, up, and down with respect to an operator facing the front of the three-dimensional printing apparatus 100. The reference signs R, L, U, and D in the drawings respectively represent right, left, up, and down. The reference signs X, Y, and Z in the drawings respectively represent a front-rear direction, a right-left direction, and an up-down direction. The front-rear direction X may also be referred to as a “scanning direction X”. The front-rear direction X corresponds to a “first direction”. The up-down direction Z corresponds to a direction in which cured layers 91 are to be stacked for three-dimensional printing. The rear side of the three-dimensional printing apparatus 100 may also be referred to as an “upstream side”. The front side of the three-dimensional printing apparatus 100 may also be referred to as a “downstream side”. The upstream side corresponds to a “first side in the first direction”. The downstream side corresponds to a “second side in the first direction”. The scanning direction X includes an onward direction X1 and a backward direction X2. As used herein, the term “onward direction X1” refers to a direction from the upstream side to the downstream side, and the term “backward direction X2” refers to a direction from the downstream side to the upstream side. These directions are defined merely for the sake of convenience of description and do not limit in any way how the three-dimensional printing apparatus 100 may be installed.

As illustrated in FIG. 1, the three-dimensional printing apparatus 100 cures a powder material 90 with a curing liquid so as to define the cured layers 91. The three-dimensional printing apparatus 100 sequentially stacks the cured layers 91 in the up-down direction Z such that the cured layers 91 are integral with each other. The three-dimensional printing apparatus 100 thus prints a desired three-dimensional object 92. In accordance with a cross-sectional image indicative of a cross-sectional shape of the desired three-dimensional object 92, the three-dimensional printing apparatus 100 according to the present preferred embodiment discharges a curing liquid onto the powder material 90 so as to cure the powder material 90. The three-dimensional printing apparatus 100 thus defines the cured layer 91 conforming to the cross-sectional image. The three-dimensional printing apparatus 100 sequentially stacks the cured layers 91 so as to print the desired three-dimensional object 92.

As used herein, the term “cross-sectional shape” refers to a cross-sectional shape obtained when a model of the three-dimensional object 92 to be printed is cut into slices in a predetermined direction (e.g., a horizontal direction) such that each of the slices has a predetermined thickness (e.g., a thickness of about 0.1 mm). Each of the slices does not necessarily have to have a constant thickness.

The powder material 90 is not limited to any particular composition or form. The powder material 90 may be powder made of any of various materials, such as an inorganic material, a metallic material, and a resin material. Examples of components of the powder material 90 include: inorganic materials, such as alumina, silica, titania, and zirconia; metallic materials, such as iron, aluminum, titanium, and an alloy thereof (which is typically stainless steel, a titanium alloy, or an aluminum alloy); water-soluble resin materials, such as polyvinyl alcohol (PVA), polyvinyl pyrrolidone (PVP), water-soluble acrylic resin, water-soluble urethane resin, and water-soluble polyamide; and other materials, such as gypsum hemihydrate (e.g., a type calcined gypsum and β type calcined gypsum), apatite, salt, starch, and plastic. The powder material 90 may be any one of these components or may be a combination of two or more of these components. The powder material 90 is, for example, mixed powder including first powder having a first average particle size D1 (in units of μm) and second powder having a second average particle size D2 (in units of μm). The second average particle size D2 is smaller than the first average particle size D1. The first average particle size D1 is about five to ten times larger than the second average particle size D2, for example. The first powder is, for example, an inorganic material. The second powder is, for example, a water-soluble resin material. Unless otherwise specified, the term “average particle size” refers to a particle size obtained when the integrated value of a particle size distribution (which is measured using a particle size distribution measuring device in accordance with a laser scattering and diffraction method) is about 50 percent, for example. In other words, the term “average particle size” refers to a “about 50 percent volume average particle size”.

The curing liquid may be any liquid that causes particles of the powder material 90 to adhere to each other. Examples of the curing liquid to be used include a liquid that binds together particles of the powder material 90. The curing liquid may be viscous. Examples of the curing liquid include a water-containing liquid, a wax-containing liquid, and a binder-containing liquid. When the powder material 90 contains a water-soluble resin material, the curing liquid may be, for example, water.

As illustrated in FIG. 1, the three-dimensional printing apparatus 100 includes a body 10, a printing tank 20, a feeding tank 30, a collecting tank 40, a spreader 50, a head unit 60, a support 70, a plate 80, and a controller 88.

As illustrated in FIG. 2, the body 10 is an outer body of the three-dimensional printing apparatus 100. The body 10 is elongated in the scanning direction X. The body 10 has a box shape. The body 10 holds the three-dimensional object 92 being printed. The body 10 is provided with the printing tank 20, the feeding tank 30, and the collecting tank 40. The body 10 includes a flat upper surface 10A (see FIG. 1). The printing tank 20, the feeding tank 30, and the collecting tank 40 are recessed from the upper surface 10A. The printing tank 20, the feeding tank 30, and the collecting tank 40 are arranged independently side by side. The body 10 supports the support 70.

As illustrated in FIG. 1, the printing tank 20 is provided in the body 10. A printing space 20A is defined in the printing tank 20. The printing space 20A stores the powder material 90 fed from the feeding tank 30. The curing liquid is discharged onto the powder material 90 so as to print the three-dimensional object 92 in the printing space 20A.

As illustrated in FIG. 1, the three-dimensional printing apparatus 100 includes a first table 24. The first table 24 is disposed in the printing tank 20. The printing space 20A is defined by the printing tank 20 and the first table 24. The powder material 90 is placed on the first table 24. The three-dimensional object 92 is printed in a portion of the printing space 20A located on or over the first table 24. The first table 24 is movable in the up-down direction Z. The first table 24 has, for example, a rectangular shape in a plan view.

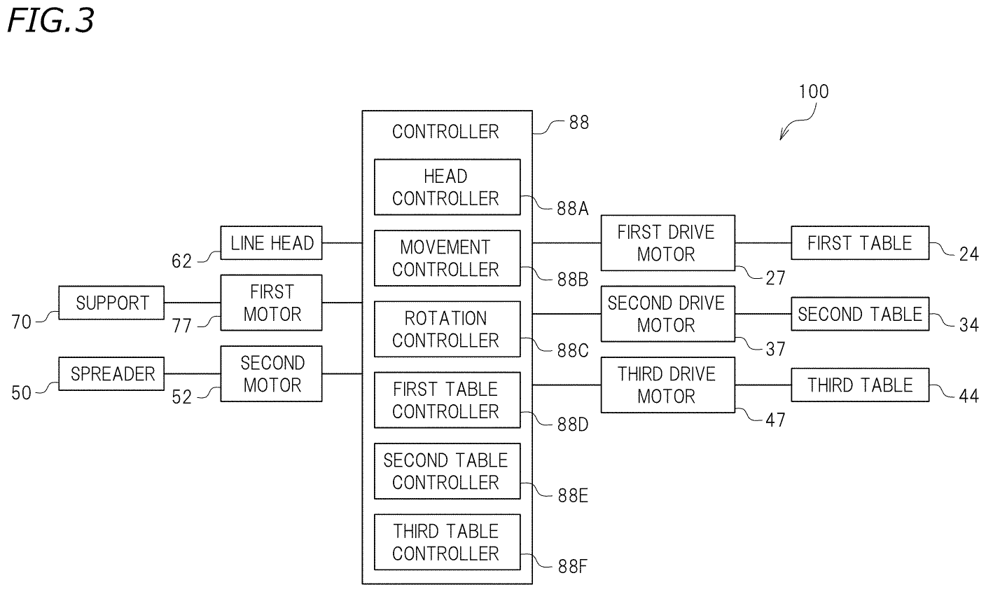

As illustrated in FIG. 1, the three-dimensional printing apparatus 100 includes a first elevator 25. The first elevator 25 raises and lowers the first table 24. In other words, the first elevator 25 moves the first table 24 in the up-down direction Z. The first elevator 25 is provided in the body 10. The first elevator 25 is not limited to any particular configuration or structure. The first elevator 25 includes a first support 26, a first drive motor 27 (see also FIG. 3), and a ball screw (not illustrated). The first support 26 is connected to the lower surface of the first table 24. The first support 26 supports the first table 24 from below. The first support 26 extends in the up-down direction Z. The first support 26 is connected to the first drive motor 27 through the ball screw. Driving the first drive motor 27 moves the first support 26 in the up-down direction Z. This moves the first table 24 in the up-down direction Z. The first drive motor 27 is electrically connected to the controller 88 and thus controlled by the controller 88. In other words, the first elevator 25 is controlled by the controller 88.

As illustrated in FIG. 1, the feeding tank 30 is provided in the body 10. The feeding tank 30 is disposed rearward of the printing tank 20. A storage space 30A is defined in the feeding tank 30. The storage space 30A stores the powder material 90 to be fed to the printing tank 20. The maximum capacity of the storage space 30A is larger than the maximum capacity of the printing space 20A. The amount of powder material 90 to be stored in the storage space 30A is thus larger than the amount of powder material 90 to be stored in the printing space 20A.

As illustrated in FIG. 1, the three-dimensional printing apparatus 100 includes a second table 34. The second table 34 is disposed in the feeding tank 30. The storage space 30A is defined by the feeding tank 30 and the second table 34. The powder material 90 is placed on the second table 34. The second table 34 is movable in the up-down direction Z. The second table 34 has, for example, a rectangular shape in the plan view.

As illustrated in FIG. 1, the three-dimensional printing apparatus 100 includes a second elevator 35. The second elevator 35 raises and lowers the second table 34. In other words, the second elevator 35 moves the second table 34 in the up-down direction Z. The second elevator 35 is provided in the body 10. The second elevator 35 is not limited to any particular configuration or structure. The second elevator 35 includes a second support 36, a second drive motor 37 (see also FIG. 3), and a ball screw (not illustrated). The second support 36 is connected to the lower surface of the second table 34. The second support 36 supports the second table 34 from below. The second support 36 extends in the up-down direction Z. The second support 36 is connected to the second drive motor 37 through the ball screw. Driving the second drive motor 37 moves the second support 36 in the up-down direction Z. This moves the second table 34 in the up-down direction Z. The second drive motor 37 is electrically connected to the controller 88 and thus controlled by the controller 88. In other words, the second elevator 35 is controlled by the controller 88.

As illustrated in FIG. 1, the collecting tank 40 is provided in the body 10. The collecting tank 40 is disposed forward of the printing tank 20. A collecting space 40A is defined in the collecting tank 40. The collecting space 40A collects an excess portion of the powder material 90 that has not been stored in the printing space 20A. The maximum capacity of the collecting space 40A is smaller than the maximum capacity of the printing space 20A. The amount of powder material 90 to be stored in the collecting space 40A is thus smaller than the amount of powder material 90 to be stored in the printing space 20A. The maximum capacities of the storage space 30A, the printing space 20A, and the collecting space 40A may have, for example, a ratio 3:2:1. The maximum capacity of the storage space 30A is measured when the second table 34 is located at its lowermost position. The maximum capacity of the printing space 20A is measured when the first table 24 is located at its lowermost position. The maximum capacity of the collecting space 40A is measured when a third table 44 (which will be described below) is located at its lowermost position.

As illustrated in FIG. 1, the three-dimensional printing apparatus 100 includes the third table 44. The third table 44 is disposed in the collecting tank 40. The collecting space 40A is defined by the collecting tank 40 and the third table 44. The powder material 90 is placed on the third table 44. The third table 44 is movable in the up-down direction Z. The third table 44 has, for example, a rectangular shape in the plan view.

As illustrated in FIG. 1, the three-dimensional printing apparatus 100 includes a third elevator 45. The third elevator 45 raises and lowers the third table 44. In other words, the third elevator 45 moves the third table 44 in the up-down direction Z. The third elevator 45 is provided in the body 10. The third elevator 45 is not limited to any particular configuration or structure. The third elevator 45 includes a third support 46, a third drive motor 47 (see also FIG. 3), and a ball screw (not illustrated). The third support 46 is connected to the lower surface of the third table 44. The third support 46 supports the third table 44 from below. The third support 46 extends in the up-down direction Z. The third support 46 is connected to the third drive motor 47 through the ball screw. Driving the third drive motor 47 moves the third support 46 in the up-down direction Z. This moves the third table 44 in the up-down direction Z. The third drive motor 47 is electrically connected to the controller 88 and thus controlled by the controller 88. In other words, the third elevator 45 is controlled by the controller 88.

As illustrated in FIG. 2, the body 10 is provided with a right guide rail 12R and a left guide rail 12L. The right and left guide rails 12R and 12L guide movement of the support 70 in the scanning direction X. The right and left guide rails 12R and 12L each extend in the scanning direction X. The left guide rail 12L is disposed leftward of the right guide rail 12R. The front ends of the right and left guide rails 12R and 12L are located forward of the collecting tank 40. The rear ends of the right and left guide rails 12R and 12L are located rearward of the feeding tank 30. The printing tank 20, the feeding tank 30, and the collecting tank 40 are disposed between the right guide rail 12R and the left guide rail 12L. Although the body 10 is provided with the right and left guide rails 12R and 12L in the present preferred embodiment, the body 10 may be provided with any number of guide rails disposed at any suitable positions.

As illustrated in FIG. 2, the support 70 is disposed on the upper surface 10A of the body 10. The support 70 is in slidable engagement with the right and left guide rails 12R and 12L. The support 70 is movable in the scanning direction X along the right and left guide rails 12R and 12L. The support 70 includes a right leg 70R, a left leg 70L, and a connector 70C. The right leg 70R is in engagement with the right guide rail 12R. The left leg 70L is in engagement with the left guide rail 12L. The connector 70C connects the upper end of the right leg 70R and the upper end of the left leg 70L to each other. The right and left legs 70R and 70L each extend in the up-down direction Z. The connector 70C extends in the right-left direction Y. The support 70 is reciprocated in the scanning direction X along the right and left guide rails 12R and 12L by a conveyor 72 (which will be described below).

As illustrated in FIG. 2, the three-dimensional printing apparatus 100 includes the conveyor 72. The conveyor 72 moves the support 70 relative to the body 10 in the scanning direction X. The conveyor 72 includes a pulley 73F, a pulley 73R, a pulley 74F, a pulley 74R, a connecting rod 75A, a connecting rod 75B, a left belt 76L, a right belt 76R, and a first motor 77 (see FIG. 3). The pulley 73F is disposed adjacent to the front end of the left guide rail 12L. The pulley 73R is disposed adjacent to the rear end of the left guide rail 12L. The pulley 74F is disposed adjacent to the front end of the right guide rail 12R. The pulley 74R is disposed adjacent to the rear end of the right guide rail 12R. The connecting rod 75A connects the pulley 73F and the pulley 74F to each other. The connecting rod 75B connects the pulley 73R and the pulley 74R to each other. The left belt 76L is wound around the pulley 73F and the pulley 73R. The right belt 76R is wound around the pulley 74F and the pulley 74R. The first motor 77 rotates the connecting rod 75A. Alternatively, the first motor 77 may rotate the connecting rod 75B. The left belt 76L is secured to the left leg 70L. The right belt 76R is secured to the right leg 70R. The first motor 77 is electrically connected to the controller 88 and thus controlled by the controller 88. In other words, the conveyor 72 is controlled by the controller 88. Driving the first motor 77 rotates the connecting rod 75A, so that the right and left belts 76R and 76L run. This causes the support 70 to reciprocate in the scanning direction X along the right and left guide rails 12R and 12L. For the sake of convenience of description, the conveyor 72 is illustrated only in FIG. 2, and illustration of the conveyor 72 is omitted in the other drawings.

As illustrated in FIG. 1, the head unit 60 according to the present preferred embodiment includes three line heads 62 and a case 64. The line heads 62 are arranged in the scanning direction X. The line heads 62 are housed in the case 64. The line heads 62 each discharge the curing liquid onto the powder material 90 stored in the printing space 20A. Each line head 62 is an example of a discharge head. Each line head 62 includes a plurality of nozzles (not illustrated) to discharge the curing liquid. The nozzles of each line head 62 are arranged in a straight line in the right-left direction Y. Each line head 62 may discharge the curing liquid in any mode. In one example, each line head 62 discharges the curing liquid in an inkjet mode. The head unit 60 is supported by the support 70 such that the line heads 62 are located above the printing tank 20. The head unit 60 is secured to the connector 70C of the support 70. The line heads 62 are thus immovable in the right-left direction Y. The lower ends of the line heads 62 are located below the lower surface of the case 64. The line heads 62 are electrically connected to the controller 88. The controller 88 controls discharge of the curing liquid from the nozzles of the line heads 62.

As illustrated in FIG. 1, the spreader 50 is disposed above the body 10. The spreader 50 includes a lower end 50B. The lower end 50B of the spreader 50 is located slightly above the body 10 such that a predetermined clearance (or gap) is created between the lower end 50B of the spreader 50 and the upper surface 10A of the body 10. The spreader 50 is disposed forward of the line heads 62. The spreader 50 is supported by the support 70. More specifically, the spreader 50 is rotatably supported by the right and left legs 70R and 70L. The spreader 50 has an elongated cylindrical shape. The spreader 50 is disposed such that its rotation axis is in parallel or substantially in parallel with the right-left direction Y. As illustrated in FIG. 2, a length L1 of the spreader 50 measured in the right-left direction Y is longer than a length L2 of the feeding tank 30 measured in the right-left direction Y. The spreader 50 conveys the powder material 90, placed on the second table 34, to the printing tank 20. The spreader 50 spreads the powder material 90 through the printing space 20A. The spreader 50 flattens the surface of the powder material 90 fed onto the first table 24. This defines a powder material layer having a uniform thickness or a substantially uniform thickness. As will be described below, the spreader 50 is able to convey the powder material 90, placed on the third table 44 and the first table 24, to the feeding tank 30. As illustrated in FIG. 2, the three-dimensional printing apparatus 100 includes a second motor 52. The second motor 52 is provided on the left leg 70L. The second motor 52 is electrically connected to the controller 88 and thus controlled by the controller 88. As illustrated in FIG. 1, driving the second motor 52 rotates the spreader 50 in a forward direction R1 or a reverse direction R2. The spreader 50 according to the present preferred embodiment reciprocates in the scanning direction X in accordance with the movement of the support 70. Printing the three-dimensional object 92 involves rotating the spreader 50 in the forward direction R1 during movement of the spreader 50 in the onward direction X1. As will be described below, returning the powder material 90 to the feeding tank 30 involves rotating the spreader 50 in the reverse direction R2 during movement of the spreader 50 in the backward direction X2.

As illustrated in FIG. 1, the plate 80 is disposed above the body 10. The plate 80 includes a lower end 80B. The lower end 80B of the plate 80 is located slightly above the body 10 such that a predetermined clearance (or gap) is created between the lower end 80B of the plate 80 and the upper surface 10A of the body 10. The lower end 80B of the plate 80 is located above the lower end 50B of the spreader 50. The lower end 80B of the plate 80 is located below an upper end 50T of the spreader 50. The plate 80 is disposed rearward of the line heads 62. The plate 80 is supported by the support 70. More specifically, the plate 80 is secured to the connector 70C. The plate 80 extends in the right-left direction Y and the up-down direction Z. The length of the plate 80 in the up-down direction Z is longer than the diameter of the spreader 50. As illustrated in FIG. 2, a length L3 of the plate 80 measured in the right-left direction Y is longer than the length L2 of the feeding tank 30 measured in the right-left direction Y. In the present preferred embodiment, the length L3 of the plate 80 measured in the right-left direction Y is equal to the length L1 of the spreader 50 measured in the right-left direction Y. The plate 80 has a C shape in a side view. Specifically, the lower portion of the plate 80 is curved rearward as it extends downward from the connector 70C, and the upper portion of the plate 80 is curved rearward as it extends upward from the connector 70C. The plate 80 includes an upper end 80T. The upper end 80T of the plate 80 is located above the upper end 50T of the spreader 50. In the present preferred embodiment, the upper end 80T of the plate 80 is located above the head unit 60. The plate 80 conveys the powder material 90, placed on the third table 44 and the first table 24, to the feeding tank 30. The plate 80 feeds the powder material 90 to the storage space 30A of the feeding tank 30. Because the lower end 80B of the plate 80 is located above the lower end 50B of the spreader 50, the plate 80 does not come into contact with the powder material 90 spread through the printing space 20A by the spreader 50. Because the upper end 80T of the plate 80 is located above the head unit 60, the plate 80 is able to convey a larger amount of the powder material 90 at a time than the spreader 50. The plate 80 according to the present preferred embodiment reciprocates in the scanning direction X in accordance with the movement of the support 70.

As illustrated in FIG. 3, the controller 88 controls all operations of the three-dimensional printing apparatus 100. The controller 88 is not limited to any particular configuration. The controller 88 is, for example, a microcomputer. The microcomputer is not limited to any particular hardware configuration. In one example, the controller 88 includes: an interface (I/F) to receive print data and other data from an external device, such as a host computer; a central processing unit (CPU) to execute a command included in a control program; a read-only memory (ROM) storing the program to be executed by the CPU; a random-access memory (RAM) to be used as a working area where the program is to be expanded; and a storage (such as a memory) that stores the program and various other data. As illustrated in FIG. 1, the controller 88 is provided inside the body 10. The controller 88, however, does not necessarily have to be provided inside the body 10. The controller 88 may be, for example, a computer disposed outside the body 10. In this case, the controller 88 is connected to the three-dimensional printing apparatus 100 such that the controller 88 is able to communicate with the three-dimensional printing apparatus 100 in a wired or wireless manner.

As illustrated in FIG. 3, the controller 88 is communicably connected to the line heads 62, the first drive motor 27, the second drive motor 37, the third drive motor 47, the first motor 77, and the second motor 52. The controller 88 thus controls the line heads 62, the first drive motor 27, the second drive motor 37, the third drive motor 47, the first motor 77, and the second motor 52.

As illustrated in FIG. 3, the controller 88 includes a head controller 88A, a movement controller 88B, a rotation controller 88C, a first table controller 88D, a second table controller 88E, and a third table controller 88F. The functions of the components of the controller 88 are implemented by a program. The program is read from a storage medium, such as a compact disc (CD) or a digital versatile disc (DVD), for example. Alternatively, the program may be downloaded from the Internet. The functions of the components of the controller 88 may be performed by, for example, processor(s) and/or circuit(s). The functions of the components of the controller 88 will be described in detail below.

The head controller 88A controls the line heads 62. The head controller 88A controls the amount of curing liquid to be discharged from the nozzles of the line heads 62 and the timing of discharge of the curing liquid from the nozzles of the line heads 62. The movement controller 88B controls the first motor 77 so as to move the support 70 in the scanning direction X. The rotation controller 88C controls the second motor 52 so as to rotate the spreader 50 in the forward direction R1 or the reverse direction R2. The first table controller 88D controls the first drive motor 27 so as to move the first table 24 in the up-down direction Z. Printing the three-dimensional object 92 involves moving the first table 24 only downward by the first table controller 88D. Returning the powder material 90 to the storage space 30A of the feeding tank 30 involves moving the first table 24 only upward by the first table controller 88D. The second table controller 88E controls the second drive motor 37 so as to move the second table 34 in the up-down direction Z. Printing the three-dimensional object 92 involves moving the second table 34 only upward by the second table controller 88E. Returning the powder material 90 to the storage space 30A of the feeding tank 30 involves moving the second table 34 only downward by the second table controller 88E. The third table controller 88F controls the third drive motor 47 so as to move the third table 44 in the up-down direction Z. Printing the three-dimensional object 92 involves moving the third table 44 only downward by the third table controller 88F. Returning the powder material 90 to the storage space 30A of the feeding tank 30 involves moving the third table 44 only upward by the third table controller 88F.

The structure and configuration of the three-dimensional printing apparatus 100 have been described thus far. The following description discusses how the three-dimensional printing apparatus 100 operates after the three-dimensional printing apparatus 100 has finished printing the three-dimensional object 92. In the present preferred embodiment, the three-dimensional printing apparatus 100 sequentially stacks the cured layers 91 in accordance with cross-sectional images indicative of cross-sectional shapes of the desired three-dimensional object 92, thus printing the desired three-dimensional object 92. The following description is based on the assumption that the support 70 is moved in the backward direction X2 twice so as to return the powder material 90, remaining in the printing space 20A and the collecting space 40A, to the storage space 30A. Alternatively, the support 70 may be moved in the backward direction X2 once so as to return the powder material 90 to the storage space 30A or may be moved in the backward direction X2 three times or more so as to return the powder material 90 to the storage space 30A.

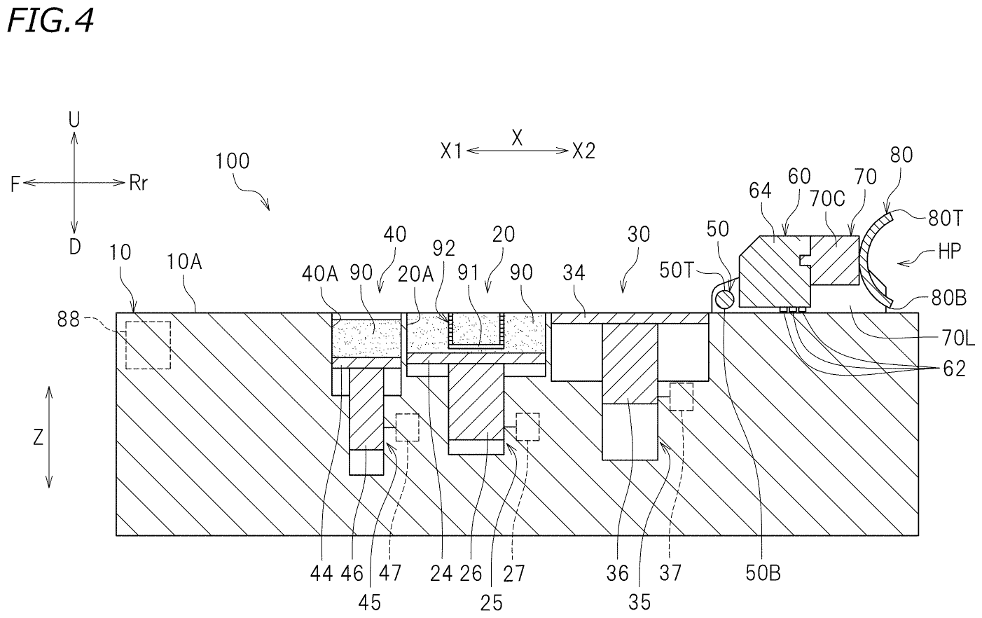

As illustrated in FIG. 4, the support 70 returns to a home position HP after the three-dimensional printing apparatus 100 has finished printing the three-dimensional object 92. As used herein, the term “home position HP” refers to a position where the support 70 is located during printing standby. Specifically, the term “home position HP” refers to a position where the support 70 (or the head unit 60 secured to the support 70) is put on standby while no three-dimensional printing is in progress. The home position HP is located rearward of the feeding tank 30. With the support 70 located at the home position HP, the three-dimensional object 92 that has been printed is embedded in the powder material 90 in the printing space 20A of the printing tank 20. An excess portion of the powder material 90 that has not been stored in the printing space 20A during printing of the three-dimensional object 92 is stored in the collecting space 40A of the collecting tank 40. In the present preferred embodiment, an entirety of the powder material 90 in the storage space 30A of the feeding tank 30 is conveyed to either the printing space 20A or the collecting space 40A. The powder material 90 may naturally remain in the storage space 30A after the three-dimensional printing apparatus 100 has finished printing the three-dimensional object 92.

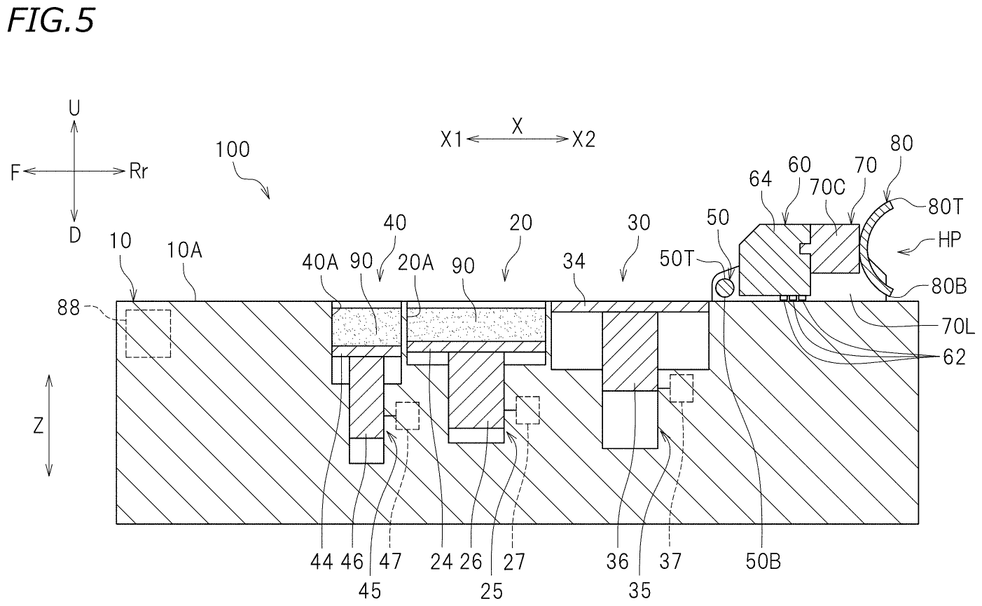

After the three-dimensional printing apparatus 100 has finished printing the three-dimensional object 92, the operator removes the three-dimensional object 92 from the printing space 20A as illustrated in FIG. 5. The operator digs up the three-dimensional object 92 from the powder material 90 using, for example, a scoop or a shovel. The powder material 90 that has not been used for three-dimensional printing remains in the printing space 20A.

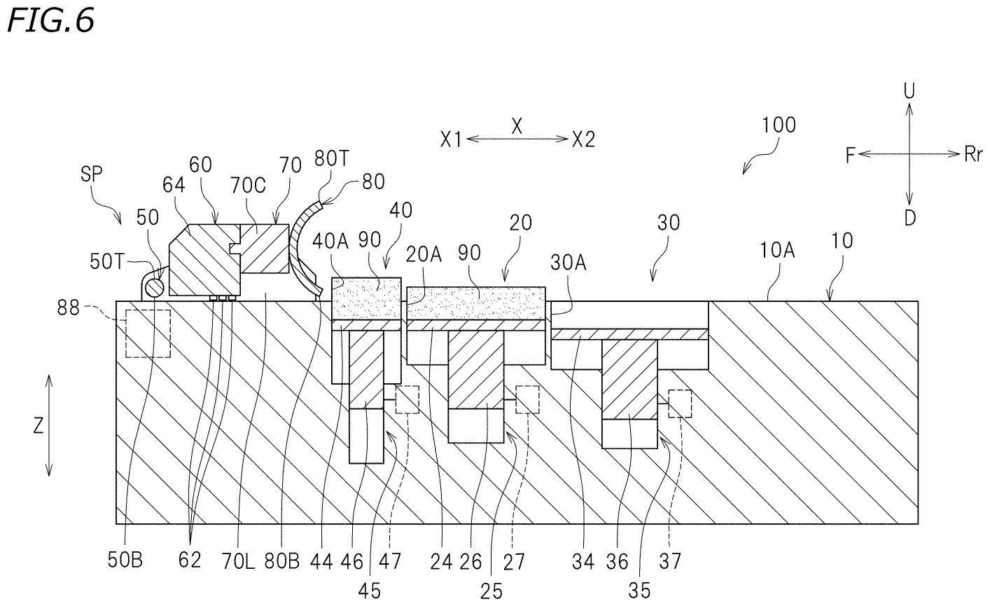

As illustrated in FIG. 6, after removal of the three-dimensional object 92 from the printing space 20A, the three-dimensional printing apparatus 100 exercises control to return the powder material 90, remaining in the printing space 20A and the collecting space 40A, to the feeding tank 30. The operator, for example, decides the timing of start of such control. First, the movement controller 88B controls the first motor 77 so as to move the support 70 in the onward direction Xl. The support 70 thus moves from the home position HP to a standby position SP. As used herein, the term “standby position SP” refers to a position where the support 70 (or the head unit 60 secured to the support 70) is put on standby immediately before the powder material 90 is returned to the feeding tank 30. The standby position SP is located forward of the collecting tank 40. The first table controller 88D controls the first drive motor 27 so as to raise the first table 24 by a predetermined distance. The third table controller 88F controls the third drive motor 47 so as to raise the third table 44 by a predetermined distance. The second table controller 88E controls the second drive motor 37 so as to lower the second table 34 by a predetermined distance. Portions of the powder material 90 placed on the first table 24 and the third table 44 are thus located above the upper surface 10A of the body 10. The distance by which the first table 24 and the third table 44 are raised and the distance by which the second table 34 is lowered when the support 70 is moved in the backward direction X2 once are respectively longer than the distance by which the first table 24 and the third table 44 are lowered and the distance by which the second table 34 is raised when the support 70 is moved in the onward direction X1 once during printing of the three-dimensional object 92. The distance by which the first table 24 and the third table 44 are raised when the support 70 is moved in the backward direction X2 once is, for example, about 1 cm. The distance by which the second table 34 is lowered when the support 70 is moved in the backward direction X2 once is, for example, about 1 cm. The distance by which the first table 24 and the third table 44 are lowered when the support 70 is moved in the onward direction X1 once during printing of the three-dimensional object 92 is, for example, about 0.1 cm. The distance by which the second table 34 is raised when the support 70 is moved in the onward direction X1 once during printing of the three-dimensional object 92 is, for example, about 0.1 cm. The distance by which the first table 24 and the third table 44 are raised when the support 70 is moved in the backward direction X2 once is shorter than a distance measured between the upper surface 10A of the body 10 and the upper end 80T of the plate 80 in the up-down direction Z. The distance by which the first table 24 and the third table are raised when the support 70 is moved in the backward direction X2 once is shorter than, for example, the length of the plate 80 measured in the up-down direction Z. The distance by which the second table 34 is lowered when the support 70 is moved in the backward direction X2 once is decided such that an entirety of the powder material 90 per conveyance is storable in the storage space 30A.

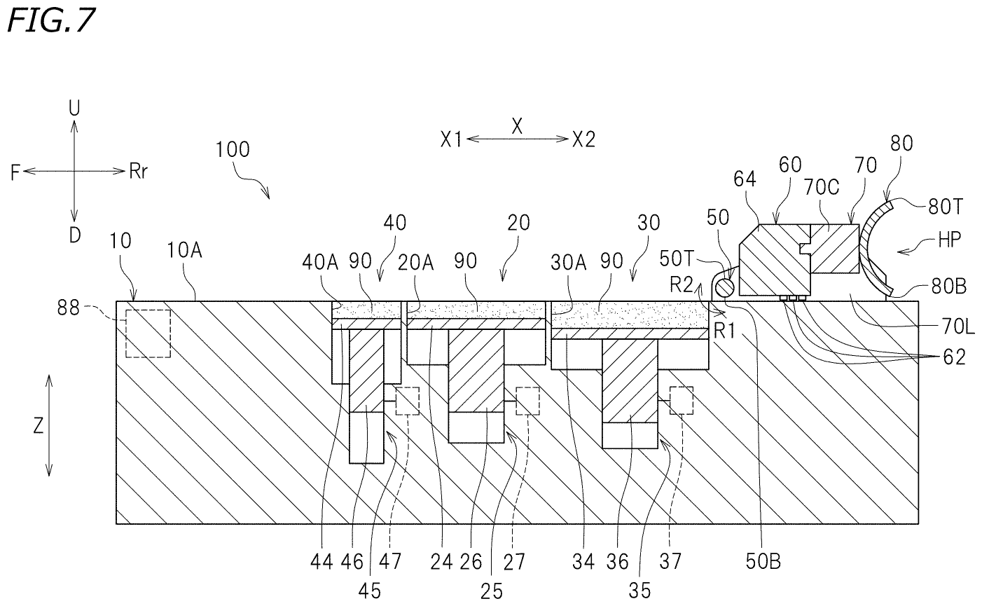

As illustrated in FIG. 7, the movement controller 88B controls the first motor 77 so as to move the support 70 in the backward direction X2. During this movement, the rotation controller 88C controls the second motor 52 so as to rotate the spreader 50 in the reverse direction R2. A portion of the powder material 90, placed on the first table 24 and located above the upper surface 10A of the body 10, and a portion of the powder material 90, placed on the third table 44 and located above the upper surface 10A of the body 10, are thus returned to the storage space 30A of the feeding tank 30 by the plate 80 and the spreader 50.

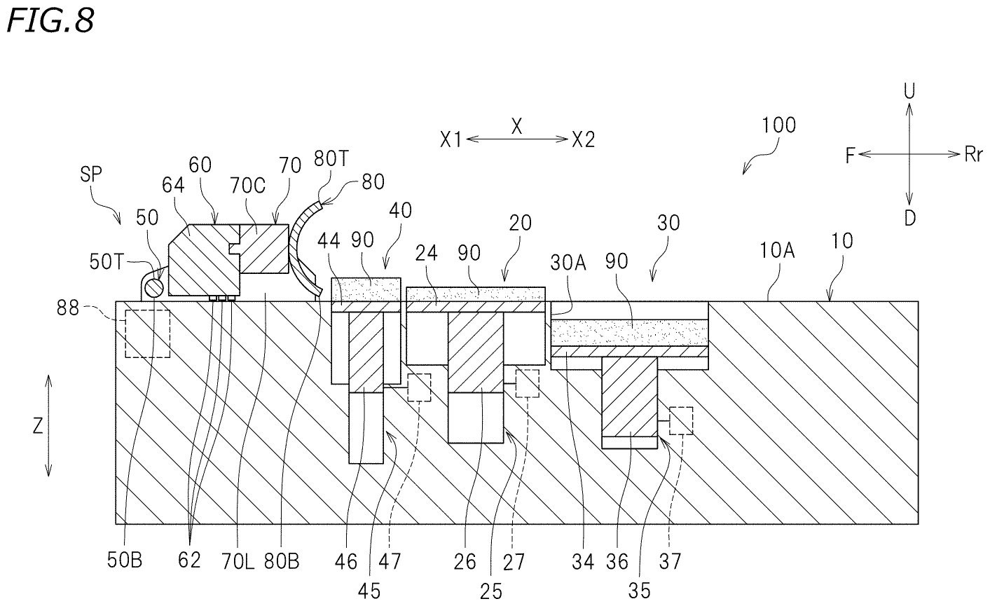

As illustrated in FIG. 8, the movement controller 88B controls the first motor 77 so as to move the support 70 in the onward direction X1 again. The support 70 is thus moved from the home position HP to the standby position SP. The first table controller 88D controls the first drive motor 27 so as to raise the first table 24 by a predetermined distance. The third table controller 88F controls the third drive motor 47 so as to raise the third table 44 by a predetermined distance. The second table controller 88E controls the second drive motor 37 so as to lower the second table 34 by a predetermined distance. The powder material 90 remaining on the first table 24 and the third table 44 is thus located above the upper surface 10A of the body 10.

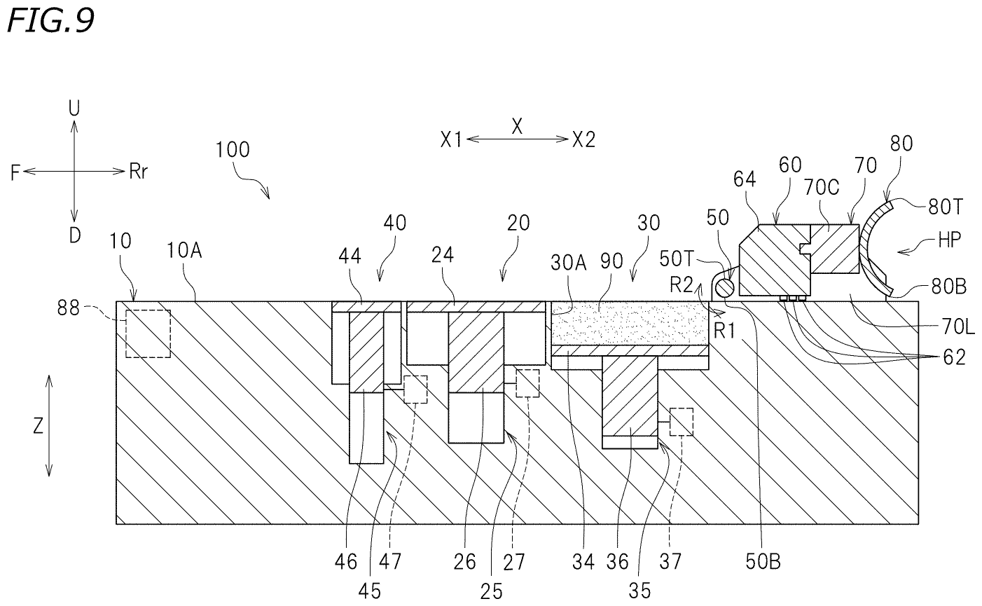

As illustrated in FIG. 9, the movement controller 88B controls the first motor 77 so as to move the support 70 in the backward direction X2. During this movement, the rotation controller 88C controls the second motor 52 so as to rotate the spreader 50 in the reverse direction R2. An entirety of the powder material 90 placed on the first table 24 and an entirety of the powder material 90 placed on the third table 44 are thus returned to the storage space 30A of the feeding tank 30 by the plate 80 and the spreader 50. Upon detecting movement of the first table 24 and the third table 44 to the highest possible positions, the controller 88 finishes exercising the control to return the powder material 90 to the storage space 30A.

As described above, after the three-dimensional printing apparatus 100 according to the present preferred embodiment has finished printing the three-dimensional object 92, the controller 88 controls the third drive motor 47 of the third elevator 45 so as to raise the third table 44, and controls the first drive motor 27 of the first elevator 25 so as to raise the first table 24. Thus, a portion of the powder material 90 placed on the third table 44 is raised above the collecting space 40A, and a portion of the powder material 90 placed on the first table is raised above the printing space 20A. The controller 88 controls the second drive motor 37 of the second elevator 35 so as to lower the second table 34. This increases the capacity of the storage space 30A of the feeding tank 30. The controller 88 moves the support 70 relative to the body 10 in the backward direction X2. During this movement, the spreader 50 supported by the support 70 conveys the portions of the powder material 90, placed on the third table 44 and the first table 24, in the backward direction X2 so as to return the portions of the powder material 90 to the storage space 30A of the feeding tank 30. Accordingly, controlling the first table 24, the second table 34, the third table 44, and the conveyor 72 in this manner easily returns the powder material 90 (which remains in the printing tank 20 and the collecting tank 40 after the three-dimensional printing apparatus 100 has finished printing the three-dimensional object 92) to the feeding tank 30.

The three-dimensional printing apparatus 100 according to the present preferred embodiment includes the plate 80 extending in the right-left direction Y and the up-down direction Z. The plate 80 is able to convey the powder material 90. Because the plate 80 extends in the right-left direction Y and the up-down direction Z, the plate 80 is able to convey a large amount of the powder material 90 at a time. In the present preferred embodiment, the plate 80 is disposed rearward of the line heads 62. When the support 70 is moved relative to the body 10 in the backward direction X2, the plate 80 comes into contact with the powder material 90 placed on the third table 44 and the first table 24 before the line heads 62 reach over the third table 44 and the first table 24. This prevents the line heads 62 from coming into contact with the powder material 90. The lower end 80B of the plate 80 is located above the lower end 50B of the spreader 50 and below the upper end 50T of the spreader 50. The plate 80 thus does not come into contact with the powder material 90 when the spreader 50 spreads the powder material 90 through the printing space 20A. The plate 80 is able to convey a large portion of the powder material 90 in returning the powder material 90 to the storage space 30A of the feeding tank 30. Consequently, the powder material 90 placed on the third table 44 and the first table 24 is easily returned to the storage space 30A of the feeding tank 30 by the spreader 50 and the plate 80.

The three-dimensional printing apparatus 100 according to the present preferred embodiment is configured such that the distance by which the third table 44 and the first table 24 move upward each time the support 70 is moved relative to the body 10 in the backward direction X2 is shorter than the length of the plate 80 measured in the up-down direction Z. This prevents the powder material 90 from being raised above the upper end 80T of the plate 80 and coming into contact with the line heads 62.

The three-dimensional printing apparatus 100 according to the present preferred embodiment is configured such that each time the support 70 is moved relative to the body 10 in the backward direction X2, the controller 88 lowers the second table 34 by the predetermined distance before the powder material 90 is returned to the storage space 30A. In one example, the second table 34 may be lowered to the lowermost position before the powder material 90 is returned to the storage space 30A of the feeding tank 30. This increases the distance between a fall start position (i.e., a position where the powder material 90 starts falling into the storage space 30A) and a landing position (i.e., a position where the fallen powder material 90 lands on the second table 34) in the up-down direction Z, so that the powder material 90 may unfortunately swirl in the air each time the powder material 90 is returned to the storage space 30A. To solve such a problem, the present preferred embodiment lowers the second table 34 by the predetermined distance each time the powder material 90 is returned to the storage space 30A. This comparatively reduces the distance between the fall start position and the landing position in the up-down direction Z. Consequently, the present preferred embodiment prevents the powder material 90 from swirling in the air.

The powder material 90 used in the three-dimensional printing apparatus 100 according to the present preferred embodiment preferably includes an inorganic material having the first average particle size D1, and a water-soluble resin material having the second average particle size D2 smaller than the first average particle size D1. When the distance between the fall start position and the landing position in the up-down direction Z is relatively long, separation of the inorganic material and the water-soluble resin material from each other may be promoted during fall of the powder material 90. To solve such a problem, the present preferred embodiment involves comparatively reducing the distance between the fall start position and the landing position in the up-down direction Z so as to reduce or prevent separation of the inorganic material and the water-soluble resin material from each other during fall of the powder material 90. Consequently, the present preferred embodiment makes it unnecessary to re-knead the powder material 90.

Although the preferred embodiments of the present invention have been described thus far, the foregoing preferred embodiments are only illustrative, and the present invention may be embodied in various other forms.

In the foregoing preferred embodiments, each time the support 70 is moved relative to the body 10 in the backward direction X2, the controller 88 lowers the second table 34 by the predetermined distance before the powder material 90 is returned to the storage space 30A. The second table 34, however, may be lowered in any other suitable manner. In an alternative example, each time the number of movements of the support 70 relative to the body 10 in the backward direction X2 reaches a predetermined number of times, the controller 88 may lower the second table 34 by the predetermined distance before the powder material 90 is returned to the storage space 30A. In another alternative example, the controller 88 may lower the second table 34 by the predetermined distance only before the support 70 is moved relative to the body 10 in the backward direction X2 for the first time.

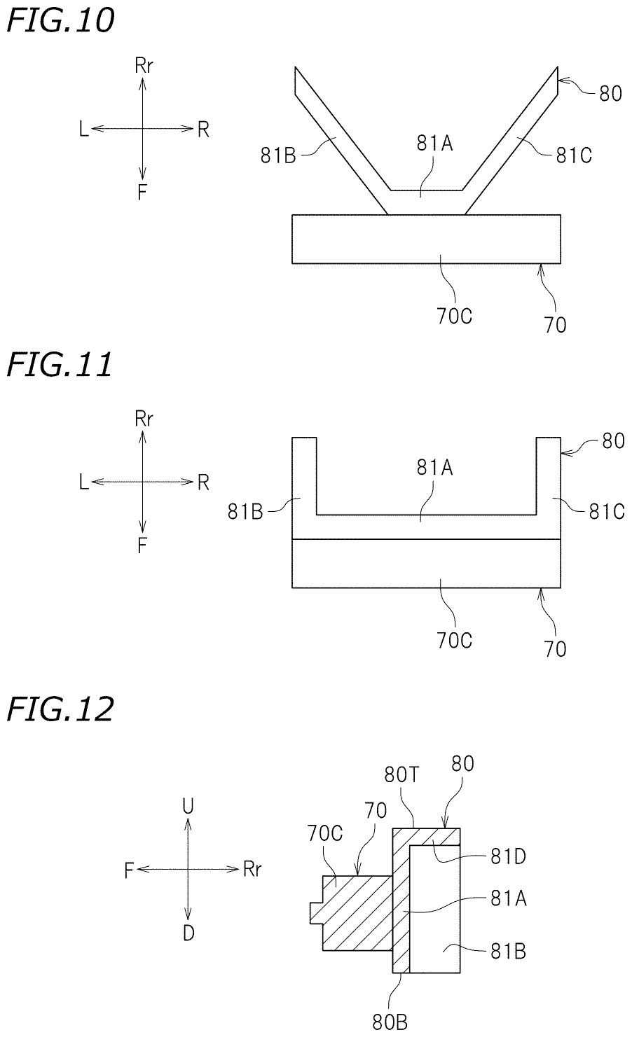

The shape of the plate 80 is not limited to that illustrated in the foregoing preferred embodiments. As illustrated in FIG. 10, the plate 80 may include, for example, a first portion 81A extending in the right-left direction Y and supported by the connector 70C of the support 70, a first side wall 81B extending obliquely rearward to the left from the left end of the first portion 81A, and a second side wall 81C extending obliquely rearward to the right from the right end of the first portion 81A. The plate 80 may thus be substantially V-shaped in the plan view. Consequently, the plate 80 illustrated in FIG. 10 is able to more reliably return the powder material 90, placed on the third table 44 and the first table 24, to the storage space 30A of the feeding tank 30.

As illustrated in FIG. 11, the plate 80 may include, for example, a first portion 81A extending in the right-left direction Y and supported by the connector 70C of the support 70, a first side wall 81B extending rearward from the left end of the first portion 81A, and a second side wall 81C extending rearward from the right end of the first portion 81A. The plate 80 may thus be substantially U-shaped in the plan view. Consequently, the plate 80 illustrated in FIG. 11 is able to more reliably return the powder material 90, placed on the third table 44 and the first table 24, to the storage space 30A of the feeding tank 30.

As illustrated in FIG. 12, the plate 80 may further include an upper wall 81D extending rearward from the upper end of the first portion 81A and connected to the upper ends of the first and second side walls 81B and 81C (see FIG. 10 or FIG. 11). Thus, if the amount of powder material 90 placed on the third table 44 and the first table 24 is relatively large, the powder material 90 would be prevented from moving beyond the plate 80 and coming into contact with the line heads 62.

In the foregoing preferred embodiments, the three-dimensional printing apparatus 100 includes the plate 80 in order to increase the amount of powder material 90 to be conveyed each time the support 70 is moved relative to the body 10 in the backward direction X2. Alternatively, the three-dimensional printing apparatus 100 may include no plate 80. In this case, the powder material 90 placed on the third table 44 and the first table 24 is returned to the storage space 30A by the spreader 50.

In the foregoing preferred embodiments, the three-dimensional printing apparatus 100 includes the line heads 62 each functioning as a discharge head. The three-dimensional printing apparatus 100, however, does not necessarily have to include the line heads 62. In an alternative example, the three-dimensional printing apparatus 100 may include a “shuttle type” ink head that functions as a discharge head. The shuttle type ink head is provided with a plurality of nozzles arranged in a straight line in the scanning direction X and is movable in the right-left direction Y.

In the foregoing preferred embodiments, the support 70 is moved relative to the body 10 in the scanning direction X. The support 70, however, does not necessarily have to be moved in this manner. In an alternative example, the support 70 may be secured to the body 10, and the printing tank 20, the feeding tank 30, and the collecting tank 40 may be moved relative to the support 70 in the scanning direction X.

In the foregoing preferred embodiments, the spreader 50 is movable together with the line heads 62. Alternatively, the spreader 50 may be movable independently of the line heads 62.

In the foregoing preferred embodiments, printing the three-dimensional object 92 involves rotating the spreader 50 in the forward direction R1 during movement of the spreader 50 in the onward direction X1. Alternatively, printing the three-dimensional object 92 may involve rotating the spreader 50 in the reverse direction R2. In the foregoing preferred embodiments, returning the powder material 90 to the feeding tank 30 involves rotating the spreader 50 in the reverse direction R2 during movement of the spreader 50 in the backward direction X2. Alternatively, returning the powder material 90 to the feeding tank 30 may involve rotating the spreader 50 in the forward direction R1.

The terms and expressions used herein are for description only and are not to be interpreted in a limited sense. These terms and expressions should be recognized as not excluding any equivalents to the elements shown and described herein and as allowing any modification encompassed in the scope of the claims. The present invention may be embodied in many various forms. This disclosure should be regarded as providing preferred embodiments of the principles of the present invention. These preferred embodiments are provided with the understanding that they are not intended to limit the present invention to the preferred embodiments described in the specification and/or shown in the drawings. The present invention is not limited to the preferred embodiments described herein. The present invention encompasses any of preferred embodiments including equivalent elements, modifications, deletions, combinations, improvements and/or alterations which can be recognized by a person of ordinary skill in the art based on the disclosure. The elements of each claim should be interpreted broadly based on the terms used in the claim, and should not be limited to any of the preferred embodiments described in this specification or referred to during the prosecution of the present application.

While preferred embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A three-dimensional printing apparatus to print a three-dimensional object by sequentially stacking cured layers each defined by a curing a powder material, the three-dimensional printing apparatus comprising:
a body to hold the three-dimensional object being printed;
a printing tank disposed in the body, the printing tank including a printing space in which the powder material is to be stored and the three-dimensional object is to be printed;
a first table on which the powder material is to be placed, the first table being disposed in the printing tank;
a first elevator disposed in the body to raise and lower the first table;
a feeding tank disposed in the body such that the feeding tank is located on a first side in a first direction relative to the printing tank, the feeding tank including a storage space to store the powder material to be fed to the printing tank;
a second table on which the powder material is to be placed, the second table being disposed in the feeding tank;
a second elevator disposed in the body to raise and lower the second table;
a spreader to convey the powder material placed on the second table to the printing tank so as to spread the powder material through the printing space;
a support supporting the spreader;
a collecting tank disposed in the body such that the collecting tank is located on a second side in the first direction relative to the printing tank, the collecting tank including a collecting space to collect an excess portion of the powder material that has not been stored in the printing space;
a third table on which the powder material is to be placed, the third table being disposed in the collecting tank;
a third elevator disposed in the body to raise and lower the third table;
a discharge head to discharge a curing liquid onto the powder material stored in the printing space;
a conveyor to move one of the body and the support relative to the other one of the body and the support in the first direction; and
a controller to control the first elevator, the second elevator, the third elevator, the discharge head, and the conveyor; wherein
after the three-dimensional printing apparatus has finished printing the three-dimensional object, the controller raises the third table and the first table, lowers the second table, and moves the support relative to the body from the second side to the first side in the first direction such that the powder material placed on the third table and the first table is returned to the storage space of the feeding tank by the spreader.

2. The three-dimensional printing apparatus according to claim 1, further comprising a plate extending in an up-down direction and a second direction that is perpendicular or substantially perpendicular to the first direction in a plan view, the plate being able to convey the powder material; wherein
the support supports the discharge head and the plate, the discharge head being disposed on the first side in the first direction relative to the spreader, the plate being disposed on the first side in the first direction relative to the discharge head;
a lower end of the plate is located above a lower end of the spreader and below an upper end of the spreader; and
the powder material placed on the third table and the first table is returned to the storage space of the feeding tank by the spreader and the plate.

3. The three-dimensional printing apparatus according to claim 2, wherein a distance by which the third table and the first table move upward each time the support is moved relative to the body from the second side to the first side in the first direction is shorter than a length of the plate measured in the up-down direction.

4. The three-dimensional printing apparatus according to claim 2, wherein each time the support is moved relative to the body from the second side to the first side in the first direction, the controller lowers the second table by a predetermined distance before the powder material is returned to the storage space.

5. The three-dimensional printing apparatus according to claim 4, wherein the powder material includes:
an inorganic material with a first average particle size; and
a water-soluble resin material with a second average particle size smaller than the first average particle size.

6. The three-dimensional printing apparatus according to claim 2, wherein the plate includes:
a first portion supported by the support, the first portion including a first end and a second end, the first end being located on a first side in the second direction, the second end being located on a second side in the second direction;
a first side wall extending from the first end of the first portion in a third direction, the third direction extending from the second side to the first side in the first direction and from the second side to the first side in the second direction; and
a second side wall extending from the second end of the first portion in a fourth direction, the fourth direction extending from the second side to the first side in the first direction and from the first side to the second side in the second direction.

7. The three-dimensional printing apparatus according to claim 2, wherein the plate includes:
a first portion extending in the second direction and supported by the support, the first portion including a first end and a second end, the first end being located on a first side in the second direction, the second end being located on a second side in the second direction;
a first side wall extending from the first end of the first portion in a fifth direction, the fifth direction extending at least from the second side to the first side in the first direction; and
a second side wall extending from the second end of the first portion in a sixth direction, the sixth direction extending at least from the second side to the first side in the first direction.

8. The three-dimensional printing apparatus according to claim 6, wherein the plate includes an upper wall extending from an upper end of the first portion in a seventh direction, the seventh direction extending from the second side to the first side in the first direction, the upper wall of the plate being connected to an upper end of the first side wall and an upper end of the second side wall.
